(19) United States
(12) Patent Application Publication
(10) Pub. No.: US 2005/0246531 A1
(43) Pub. Date: Nov. 3, 2005

(54) System and method for secured access for visitor terminals to an IP type network

(76) Inventor: Alain Fabre, Maurepas (FR)

Correspondence Address: MILES & STOCKBRIDGE PC, 1751 PINNACLE DRIVE, SUITE 500, MCLEAN, VA, 22102-3833, US

(21) Appl. No.: 11/115,419

(22) Filed: Apr. 27, 2005

(30) Foreign Application Priority Data
Apr. 28, 2004 (FR) 04 04 537

(51) Int. Cl. H04L 9/00

(52) U.S. Cl. 713/168; 713/171

(57) ABSTRACT

The invention relates to a method for secured access for at least one visitor terminal (15) to a host network (10), wherein it comprises:
providing said visitor terminal with a temporary secret key (17) and a connection automaton to said host network used to be directly executed on said visitor terminal (15), said secret key (17) being shared with an authentication service (14) controlling access to said host network, and
executing said automaton on said visitor terminal (15), said execution allowing to establish a connection with said authentication service (14), the implementing of a mutual authentication process between said visitor terminal and said authentication service according to a cryptographic protocol using said shared secret key, and the connecting of said visitor terminal to said host network if authentication was successful.

The invention lies in the field of controlled access to an IP type data network, typically an intranet network or the Internet network, and more precisely relates to a system and method for secured access for visitor terminals to an IP type local area host network.

The invention can be implemented to control access to an IP network accessed via a wireless local access network, notably using the wireless transmission technology based on the standardised 802.11 wireless network and its developments, grouped under the title WiFi (Wireless Fidelity). However, the invention can also be used to control access to a landline IP network, for example of Ethernet type.

The field of authentication to secure access to an IP network is laden with standards and various techniques, which range from straightforward use of an identifier/password couple to the implementing of more complex systems such as the OPT protocol (One Time Password) or the EAP protocol (Extensible Authentication Protocol), as well as systems based on public key infrastructures.

All the same, in the context of IP networks accessed via a WiFi type radio connection, a specificity regarding their access lies in the fact that it is not a localised access, but an extended, uncontrollable access, thus rendering the management of access to the network for visitors difficult. Moreover, a first reason that explains the security problems of WiFi networks lies in the fact that the type of connection for these networks is based on a radio transmission, which propagates ‘through the air’. The radio range can thus, either extend beyond the company's walls, in respects to a WiFi network deployed within a company, or intentionally cover a public area, in respects to a “Hotspot” type WiFi network. This results in a risk of accommodating certain dishonest visitors with the aim of fraudulently using the computing resources of companies or Hotspot owners.

A second reason that explains the security problems associated with WiFi access is intrinsic with the 802.11b standard, which in this respect has loopholes. The security problems were indeed neglected by those who designed the WiFi standard, with the direct result that the initial WEP protocol (Wired Equivalent Privacy), implemented to protect the WiFi networks, was broken.

Over and above the preceding, the flaw of radio networks that use the 802.11 technology is principally due to three points, among which incorrect automatic implementation of the encryption algorithm RC4 on which the WEP is based, the non-management of keys resulting in the sharing of the same key by all the visitors, the key moreover being static, and the non-authentication based on a mechanism for transmitting encrypted challenges/replies via the WEP rendering the establishing of the key possible.

The responsibility for handling the problem related to secure access to WiFi networks lies with three standards agencies: the IEEE (Institute of Electrical and Electronic Engineers), the IETF (Internet Engineering Task Force) and the WiFi Alliance.

The IEEE has thus improved the situation by defining the IEEE 802.1X standard, which allows to provide a secured infrastructure that authenticates the visitors by adapting the authentication protocol EAP (Extensible Authentication Protocol) and its various authentication methods to radio transportation. This standard is principally constructed of two subsections consisting in a dynamic management and creation of keys to be used with the WEP of the 802.11 and an authentication of the visitor via a Radius type EAP server, depending on the chosen authentication method.

The IEFT in turn corrected some inadequacies associated with the implementation of the EAP, by defining the PEAP protocol (Protected EAP). This protocol notably consists in sending the authentication elements (identifier/password) between the visitor and the wireless access to the network via a secured and encrypted TLS tunnel (Transport Layer Security).

The WiFi Alliance proposes a standard entitles WPA (WiFi Protected Access) which uses the results obtained by the workgroup 802.11i of the IEEE. WPA defines the dynamic confidentiality, integrity and distribution mechanisms of the keys. This protocol allows the implementation of two authentication mechanisms via group secret or via PEAP. WPA should render access control more robust. Thus, according to the WPA, the authentication server is responsible for supplying the keys for temporary encryption of TKIP type (Temporal Key Integrity Protocol) and it is these keys which will allow the visitor to be authenticated by the server in order to gain access to the network.

However, the inconvenience of these aforementioned standardised authentication protocols, that allow secured access to a wireless local network, is that it needs, for implementation purposes, to be deployed and handled by the operating systems of the visitor terminals which want to connect to the network.

However, by imposing a standardised technique to perform authentication at the point of access to the network, not all the different visitor terminal configurations are covered. Thus, a visitor terminal whose operating system has not be set-up to handle the authentication process imposed by the chosen standard to secure access to the local network will not be able to access the network without first carrying out necessary works to render a piece of equipment or software capable of operating on the visitor terminal so as to implement the standardised authentication process.

Additionally, the disclosed different standards which allow to secure access to a wireless local network do not consider the problem of adaptation of visitor terminals whose configuration is unknown and on which we can not carry out any work. These different authentication protocol standards can not automatically be used as it depends on the technical status of the terminal being used by the visitor and its configuration.

The purpose of the invention is to overcome these inconveniences by proposing a method for secured access for visitor terminals to an host network via a wireless as well as a landline connection, which is totally independent of the configuration of the visitor terminals, in order to be specifically implemented in the case of not having control over the configuration of the visitor terminals or where we do not want to impose a given standardised security protocol,

The present invention is able to be implemented in all types of host network (such as a network in a hotel, a local area network.)

With this in mind, the purpose of the invention is a method for secured access for at least one visitor terminal to a host network, wherein it comprises:
providing said visitor terminal with a temporary secret key and a connection automaton to said host network used to be directly executed on said visitor terminal, said secret key being shared with an authentication service controlling access to said host network, and
executing said automaton on said visitor terminal, said execution allowing to establish a connection with said authentication service, the implementing of a mutual authentication process between said visitor terminal and said authentication service according to a cryptographic protocol using said shared secret key, and the connecting of said visitor terminal to said local host network if authentication was successful.

Advantageously, the temporary secret key and the connection automaton are recorded onto a memory device that can be connected directly to said visitor terminal, so that the stored information in said memory device can be read directly by said visitor terminal without any prior installation.

Preferably, the temporary secret key is different for each visitor terminal that wishes to access the host network.

According to a feature of the invention, the temporary secret keys respectively provided to each visitor terminal of the host network together with the connection automaton, are calculated for a set duration, preferably one day.

According to an embodiment, a hidden validation number is moreover stored in a section of the memory of the memory device unknown to the visitor terminal, the establishment of the connection with the authentication service via the connection automaton being subject to prior verification of the validation number at the time of execution by said automaton.

Preferably, the validation number associated with each memory device is renewed at a pre-set time interval, preferably on a daily basis.

Preferably, the mutual authentication process between the visitor terminal and the authentication service is renewed at regular intervals of controllable duration once access to the network has been authorised for the visitor terminal, said terminal being disconnected from the network if the authentication fails.

The invention also relates to a system for secured access for at least one visitor terminal to a host network, wherein it comprises, for each visitor terminal that wants to access the network, a memory device that can be directly connected to said visitor terminal, comprising a temporary secret key and a connection automaton to said network used to be executed directly on said visitor terminal, said system further comprising an authentication service hosted by the network and sharing said temporary secret key, said automaton comprising means for initiating a mutual authentication process between said visitor terminal and said authentication service according to a cryptographic protocol using said shared secret key, and means for connecting said visitor terminal to said host network if the authentication was successful. preferably, the memory device comprises a memory key used to be connected to a USB port of the visitor terminal (15).

According to an embodiment, the system comprises a temporary secret key creation service hosted by the host network, said service comprising means for automatically transmitting the temporary secret keys created by the authentication service.

According to an embodiment, the system comprises a management unit for the memory devices connected to the host network, said unit comprising means for recuperating, upon request, the temporary secret keys from the temporary secret key creation service and means for booting each memory device respectively with a temporary secret key.

Advantageously, the system comprises means for securing the temporary secret key exchanges within the host network between the secret key creation service and the management unit for the memory devices on one hand, and the secret key creation service and the authentication service on the other hand.

Preferably, the means for securing the exchanges implements a symmetric key encryption algorithm.

According to a preferred embodiment, the host network is a wireless network according to the WiFi standard.

According to an alternative, the host network is a landline Ethernet network.

Other features and advantages of the invention will become clearer upon reading the following description given by way of non-restrictive illustration and in reference to the annexed figures in which;

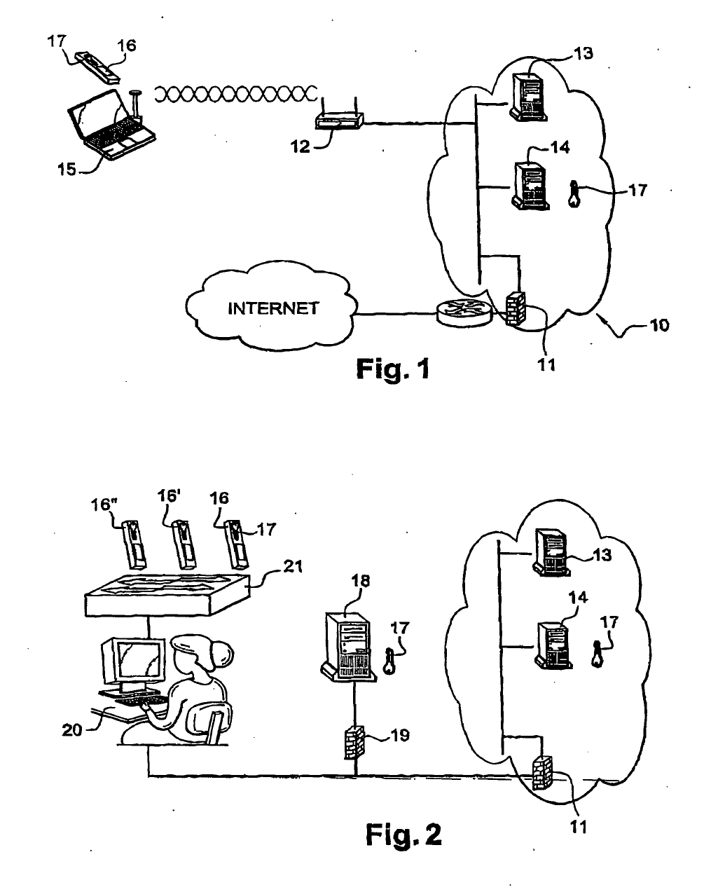

FIG. 1 illustrates the architecture of the system for secured access via a wireless connection WiFi to an IP type local host network according to the invention;

FIG. 2 illustrates the production infrastructure within a local host network, memory devices on which the principle is based for secured access to the local host network according to the invention; and

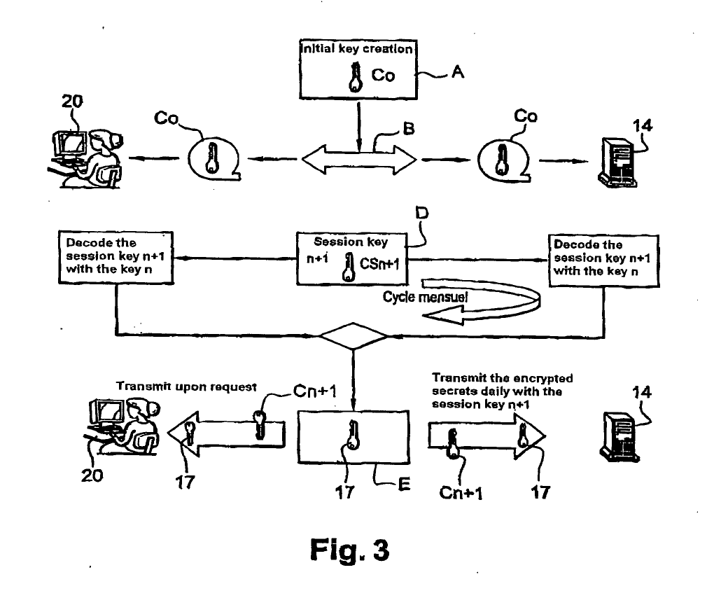

FIG. 3 illustrates the principle for securing exchanges between the different entities of the network participating in the control management of access to the network according to the invention.

The following description refers to access by visitor terminals to the Internet, made available by a host company via a WiFi type local network for wireless access. Within the scope of the invention, access to the Internet can also be made available for visitor terminals via a host Internet service provider through the use of a hotspot, allowing connection to the Internet via a WiFi type local network for wireless access.

However, it is appropriate to note that the invention can also be implemented when access to the Internet is to be obtained via a landline Ethernet type network.

FIG. 1 therefore illustrates the architecture of the system according to the invention for the securing of access to an IP type wireless local host network 10. The local host network benefits from a standard infrastructure for 802.11b or 802.11g type wireless access, with a firewall 11 allowing to control access to the Internet. Depending on the security policy of the host company, this controlling can be more or less stringent. For example, some companies may wish to filter the non-professional URLs via Proxy servers. This aspect is however out with the context of the invention.

The architecture represented in FIG. 1 comprises a set of 802.11b or 802.11g type wireless ports, which allow coverage of the zone dedicated to the host company's visitors (meeting room, auditorium, reception room . . . ).

The IP local access network normally comprises a DHCP service embedded in a DHCP server 13, which centralises and manages the allocation of TCP-IP configuration data, by automatically allocating the IP addresses to the visitor terminals 15 configured to use the DHCP protocol.

According to the invention, the system for secured access for a visitor terminal to a local host network further comprises an authentication service 14, embedded in a server hosted by the local network.

However, it can easily be envisaged that the different services described above, that being the DHCP service, the authentication service and the service for controlled access to the Internet (implemented by the firewall for example) are embedded in a single machine.

Thus, according to the invention, when a visitor arrives at the company's reception, if the latter wishes to benefit from access to the Internet via the company's WiFi type local host network, he is provided with a memory device 16, that can be directly read by his terminal 15 without the need for any prior installation. The visitor terminals 15 intended to be used within the context of the invention preferably comprise laptops integrating at least a WiFi communication adapter and/or an Ethernet connection engineering. The invention can also be implemented with PDA type terminals.

The memory device 16 preferably comprises an electronic memory key used to be connected to a USB port of a visitor terminal and to be compatible with the majority of extant operating systems likely to be installed on the visitor terminals. A memory key with a capacity of 64 Mb for example is sufficient for implementing the invention. The memory device can also be constituted of a CD-ROM or a diskette, In the description that follows, we will discuss a memory device without judging in advance the data support technology in use.

According to the invention, the memory device 16 provided to a visitor terminal 15 desirous of accessing the services offered by the network, embeds a temporary secret key 17 and a connection software automaton to the local host network, more precisely loaded to carry out the authenticating of the visitor in order to secure access to the network. The software automaton recorded in the memory device is used to be directly executed on the visitor terminal and recognise the temporary secret key.

The secret key 17 recorded in the memory device is said to be temporary as it has a fixed term of validity, preferably one day. However, the interval according to which the temporary secret keys used by the system are recalculated is at the host company's discretion.

Each temporary secret key 17 embedded into a memory device 16 provided to a visitor terminal 15, is shared by the authentication service 14 of the network. Preferably, in order to allow individual authentication of the memory devices 16 provided to the visitor terminals, the embedded temporary secret keys are all different to each other.

According to a specific embodiment of the invention, the memory devices 16 additionally embed a validation number hidden in a section of the memory of the memory device not known to the visitor terminal. The location of this validation number, as well as the number itself, are on the contrary known to the software automaton. The validation number associated to each memory device is used to be renewed at a pre-set time interval, preferably daily.

As we will see later on, this precaution procures an additional level of security allowing the system to guard against an attempt at copying contents of the memory device onto several other terminals, from one visitor terminal to which the memory device was legitimately provided.

When the visitor arrives in a WiFi coverage area he will associate his visitor terminal 15 to the WiFi port 12, then he will connect, to his terminal, the memory device 16 that the host company's reception provided him with. The visitor terminal will then launch the connection software automaton which is used to remain active throughout the session. The software automaton is activated by clicking on the corresponding executable file sated in the memory device.

Preferably, the executable file of the automaton is sealed and its first operation is to check its integrity, this operation allows provide a guarantee to the visitor that the program is virus free.

Secondly, the automaton will check the daily validation number of the memory device. To do this, the automaton is programmed to known where the memory is located which holds this validation number, unknown to the visitor terminal. If this verification step fails, access to the network by the visitor terminal is refused. In this way, if the content of the memory device, that being the temporary secret key and the connection automaton, is copied onto another terminal, the executing of the automaton on this other terminal will lead to access being refused as the automaton will not be able to validate the prerequisite daily number verification step, the latter normally can not be copied onto another terminal. Only a visitor terminal equipped with a memory device thus being able to initiate the procedure for secured access to the network.

Once the prerequisite daily number verification step has been validated, the automaton establishes a connection with the authentication service 14 so as to implement a mutual authentication procedure between the visitor terminal and the authentication service.

More precisely, after having recuperated an IP address and the temporary secret key, the automaton will open a TCP/IP session with the authentication server, for which it knows the address and the listening port. As the temporary secret key is shared by the authentication service and the memory device connected to the visitor terminal, the TCP/IP connection initialised between the authentication service and the visitor terminal is encrypted and therefore, a mutual authentication process on the client server mode is performed according to a standard cryptographic protocol. The applied standard cryptographic protocol is for example based on the AES (Advanced Encryption Standard) type symmetric key encryption algorithm, with a 128 bit key.

If the mutual authentication was successful, the visitor terminal will receive a message allowing it access to the network. The session of the visitor terminal is then authorised and the visitor terminal can use the services provided by the network and notably access to the Internet.

The authentication service according to the invention then creates a memory map associating the temporary secret key and the IP address allocated to the visitor terminal.

The connection automaton remains active throughout the session and the mutual authentication process is used to be renewed at regular intervals. Thus, at regular intervals of controllable duration, the automaton is used to re-execute the mutual authentication with the authentication service. This additional verification allows to ensure that the IP address of the visitor terminal is not usurped.

During the active period of the session, the automaton also checks whether the memory device is properly connected to the visitor terminal or not and, in the event of the memory device being removed by the visitor, whether the automaton is programmed to automatically stop or not.

At the end of the visit, the visitor removes the memory device from his terminal and returns it to the host company's reception for example.

FIG. 2 illustrates the production infrastructure within a local host network, memory devices to be provided to the visitors and on which the system for secured access to the local host network is based according to the invention.

The creation of memory devices is for example done on a daily basis, the renewal rhythm of these memory devices being however left to the discretion of the host company. The creation of the memory devices principally comprises the calculation of the temporary secret keys used to be sent to the authentication service, and the actual initialisation of said devices with the calculated temporary secret keys.

The calculation steps of the temporary secret keys and their sending to the authentication service are automatic. Considering for example that the calculation of the temporary secret keys is renewed every day, these steps are intended to start for example before the start of each day at a controllable set time. The system according to the invention thus comprises a temporary secret key creation service 18 comprising means for calculating random secret keys 17 and for automatically transmitting them to the authentication service 14. This secret key creation service 18 is hosted by a server within the local host network, for which access is protected, for example by a firewall type device 19.

The secret key creation service is only used to be accessed by a management unit for the memory devices 20, connected to the local host network. The management unit for the memory devices 20 preferably comprises a microcomputer installed in the company's reception.

The creation of memory devices 16, 16′, 16″ is therefore launched by the management unit 20, To do this, the temporary secret keys previously calculated by the secrets creation service 18, are transmitted upon request to the management unit 20 in order to initialise the memory devices 16, 16′, 16″. For this purpose, the management unit 20 has a computer program allowing it to search for and present upon request the temporary secret keys from the secret key creation server. Once the temporary secret keys are made available to the management unit, the program is used to write them onto the memory devices 16, 16′, 16″ on to which the connection software automaton was previously recorded. The latter can however be written on a memory device at the same time as the writing of the temporary secret key. To implement this initialisation step of the memory devices with the temporary secret keys, the memory devices can be connected to the USB hub linked up to the management unit 20, the number of hub channels being proportional to the average number of visitors received by the company.

The temporary secret key exchanges within the local network between the secret key creation service 18 and the management unit of the memory devices 20 on one hand, and the secret key creation service 18 and the authentication service 14 on the other hand, are preferably secured, as illustrated in FIG. 3. The temporary secret key exchanges within the local network are for example secured by the implementing of a symmetric key encryption algorithm, for example according to the AES standard.

For this reason, the temporary secret key exchanges are secured by using session keys Cn, renewable at controllable periods. These session keys are for example renewed on a monthly basis.

In a first step A, an algorithm used for this purpose in the secret key creation service, calculates an initial random key CO, for example an AES type 128 bit key, which will allow the securing of the exchanges between the secret key creation service 18, the management unit 20 and the authentication service 14. This key CO is then manually installed in step B onto the management unit 20 and the authentication service 14 so as to initialise the process. Then, the renewal of the session keys between the different contributors which are the management unit 20 and the authentication service 14 is done automatically.

More precisely, the renewal of the session keys used to interfere with the temporary secret key exchanges within the network takes place as follows. At regular intervals, each month for example, the algorithm in step D creates a new session key Cn+1, which is sent to the management unit 20 and to the authentication service 14 in encrypted form with the session key Cn, already shared by each other. The management unit 20 and the authentication service 14 are then capable of decoding the new session key n+1 with the old session key n, previously held by them. The sharing of the new session key Cn+1 between the secret key creation service, the authentication service and the management unit thus allows to secure the exchanges between them.

In this manner, each temporary secret key 17, calculated by the secret key creation service 18 to be stored in a memory device for the implementing of the system for secured access according to the invention, can be transmitted in encrypted form within the network with the session key Cn+1 according to an AES type encryption algorithm for example. This transmitting is done automatically for the authentication service 14 and upon request for the management unit 20.

Thus, thanks to the memory device handed over at the reception embedded with a temporary secret key and a connection and identification software automaton, the authentication of a visitor terminal can be ensured enabling him access to the network, whilst being total independent of the configuration of the visitor terminal.

1. Method for secured access for at least one visitor terminal (15) to a host network (10), wherein it comprises:
providing said visitor terminal with a temporary secret key (17) and a connection automaton to said host network used to be directly executed on said visitor terminal (15), said secret key (17) being shared with an authentication service (14) controlling access to said host network, and
executing said automaton on said visitor terminal (15), said execution allowing to establish a connection with said authentication service (14), the implementing of a mutual authentication process between said visitor terminal and said authentication service according to a cryptographic protocol using said shared secret key, and the connecting of said visitor terminal to said host network if authentication was successful.

2. Method set forth in claim 1, wherein the temporary secret key (17) and the connection automaton are recorded onto a memory device (16) that can be connected directly to said visitor terminal (15), so that the stored information in said memory device can be read directly by said visitor terminal without any prior installation.

3. Method set forth in claim 1, wherein the temporary secret key (17) is different for each visitor terminal that wishes to access the host network.

4. Method set forth in claim 1, wherein the temporary secret keys (17) respectively provided to each visitor terminal (15) of the local host network together with the connection automaton, are calculated for a set duration.

5. Method set forth in claim 2, wherein a hidden validation number is moreover stored in a section of the memory of the memory device unknown to the visitor terminal, the establishment of the connection with the authentication service (14) via the connection automaton being subject to prior verification of the validation number at the time of execution by said automaton, at the time of execution, by said automaton.

6. Method set forth in claim 5, wherein the validation number associated with each memory device is renewed at a preset time interval.

7. Method set forth in claim 1, wherein the mutual authentication process between the visitor terminal (15) and the authentication service (14) is renewed at regular intervals of controllable duration once access to the network has been authorised for the visitor terminal, said terminal being disconnected from the network if the authentication fails.

8. System for secured access for at least one visitor terminal (15) to a host network (10), wherein it comprises, for each visitor terminal that wants to access the network, a memory device (16) that can be directly connected to said visitor terminal (15), comprising a temporary secret key (17) and a connection automaton to said network used to be executed directly on said visitor terminal, said system further comprising an authentication service (14) hosted by the network and sharing said temporary secret key, said automaton comprising means for initiating a mutual authentication process between said visitor terminal (15) and said authentication service (14) according to a cryptographic protocol using said shared secret key (17), and means for connecting said visitor terminal to said host network if the authentication was successful.

9. System set forth in claim 8, wherein the memory device (16) comprises a memory key used to be connected to a USB port of the visitor terminal (15).

10. System set forth in claim 8, wherein it comprises a temporary secret key creation service (18) hosted by the local host network, said service comprising means for automatically transmitting the temporary secret keys created by the authentication service (14).

11. System set forth in claim 10, wherein it comprises a management unit for the memory devices (20) connected to the local host network, said unit comprising means for recuperating, upon request, the temporary secret keys from the temporary secret key creation service (18) and means for booting each memory device respectively with a temporary secret key.

12. System set forth in claim 11, wherein it comprises means for securing the temporary secret key exchanges within the host network between the secret key creation service (18) and the management unit for the memory devices (20) on one hand, and the secret key creation service (18) and the authentication service (14) on the other hand.

13. System set forth in claim 12, wherein the means for securing the exchanges implements a symmetric key encryption algorithm.

14. Method set forth in claim 9, wherein the host network is a wireless network according to the WiFi standard.

15. Method set forth in claim 9, wherein the host network is a landline Ethernet network.

16. Memory device (16), wherein it comprises means for connecting to a terminal and means for storing a temporary secret key and a connection automatom to a host network, said automatom comprising means for implementing a mutual authentication process between said Terminal and an authentication service hosted by the network according to a cryptographic protocol using said secret key.
